(19) United States
(12) Patent Application Publication
(10) Pub. No.: US 2011/0022430 A1
(43) Pub. Date: Jan. 27, 2011

(54) Method and an apparatus for calculating a risk reserve value for a machine

(76) Inventors: Uwe Held, Erlangen (DE); Georg Neuner, Erlangen (DE); Ariane Sutor, Gräfelfing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/508,664

(22) Filed: Jul. 24, 2009

(51) Int. Cl. G06Q 99/00

(52) U.S. Cl. 705/7

(57) ABSTRACT

A method and a respective apparatus for calculating a risk reserve value for a machine is provided. A risk reserve value for a machine is a potential penalty the manufacturer of a machine has to pay to the owner or operator of the machine in case the machine does not start at a guaranteed success probability value. The method and respective apparatus can be used in business considerations as well as the construction of machines with regard to provide guarantee values to a customer.

### BACKGROUND OF THE INVENTION

The present invention is directed to a method and a respective apparatus for risk analysis and especially to a method and an apparatus for calculating an overall risk reserve value for a machine. The risk reserve value can be a monetary risk reserve value or a risk reserve value of a physical entity such as power. The present invention further provides a method and a respective apparatus for calculating an overall risk reserve value for a machine. The invention furthermore provides a computer program being adapted to perform at least one of said methods and a data carrier, which stores said computer program.

Machines, such as technical devices, may be designed for a continuous operation. However, some application scenarios require to switch of said machine and/or to interrupt said machine. In case of such a switch off or interruption a restart of the machine is necessary. It may occur that it is not feasible to restart a machine due to technical problems. In such a case the manufacturer of the machine has to pay the owner/operator of the machine a calculated amount of money as a penalty. For calculating the amount of money, which has to be paid as a penalty, a guarantee value is considered. The guarantee value describes an assurance issued by the manufacturer to which extent the sold machine is reliable.

For providing a guarantee value the manufacturer typically specifies a reliability as it may be successful to start said, machine. A successful start of the machine may be defined as a provision of a required output within a limited time duration.

A machine is for example formed by a power plant. As the power consumption of a manufacturing plant or any other consumer is not constant, it may be necessary to switch an additional number of power plants on at the time when consumption peaks occur. A power plant consists of a variety of technical parts, which may fail to start. This failure of start results in a denial of a successful start of the power plant. If a guaranteed success probability value is not fulfilled by the power plant, usually a liquidated damages value has to be paid by the manufacturer to the owner/operator of the power plant. To be able to pay this penalty payment the manufacturer has to provide a certain amount of money, also referred to as monetary risk reserve value.

A risk reserve value of a machine has to be defined along with technical considerations in the conception of a machine. Several technical design decisions during the conception of the machine have to be considered as a function of the risk reserve value. Hence, the risk reserve value may influence also technical decisions in the design of a machine. Furthermore, for a calculation of a risk reserve value technical features of a machine have to be considered. It may be necessary, not only to consider the machine as a whole, but also to evaluate the reliability of single parts of said machine. Hence, also empirical studies involving single parts of said machine may be of importance for calculating a risk reserve value. Hereby, several conditions in which the machine operates have to be considered.

Commonly known methods for calculation of risks apply techniques which are known as risk analysis or risk engineering. These techniques involve the identification and evaluation of risk factors in a project. Such processes are typically performed continuously and in several iterations. Commonly known methods are hence labour intensive and costly. Since typically several project and risk managers are involved in said risk analysis or risk engineering processes the obtained results may be unreliable.

It is therefore an object of the present invention to provide a method and an apparatus for calculating a risk reserve value of a machine, the method and the apparatus performing efficiently the calculation of a reliable risk reserve value for said machine.

### SUMMARY OF THE INVENTION

The invention provides a method for calculating a risk reserve value for a machine. The method comprises the following steps: In a first step a calculation of the differences between all possible success probability values pₐᵢ, each being lower than a guaranteed success probability value p_{g}, and the guaranteed success probability value p_{g} of said machine is performed. Further, a probability of occurrence of any value of the possible success probability values pₐᵢ is calculated. Next step is multiplying the calculated differences between the possible success probability values pₐᵢ and the guaranteed success probability value p_{g} with the probability of occurrence of the possible success probability values pₐᵢ and with the provided liquidated damages regulation LD. In a final step a summing-up of each of the multiplication results for obtaining the risk reserve value is performed.

A manufacturer offers a machine for sale and therefore typically provides the customer with a guaranteed success probability value p_{g} of said machine. The guaranteed success probability value p_{g} defines how reliable a machine shall start or restart. Hence, the customer is provided with a percentage of estimated successful starts of the machine. A successful start is an attempt to start, which results in the machine being able to provide a predefined output. The machine may, for instance, be a power plant. A successful start of the power plant may be performed if the power plant delivers enough power to serve a predefined number of consumers in a specified time. An unsuccessful start of the machine is a start attempt which fails to bring about a predefined output. The probability value for an unsuccessful start is defined as 1-p.

In case the machine does not reach the guaranteed success probability value p_{g} which means an actually reached success value is below the guaranteed success probability value p_{g}, a liquidated damage LD has to be paid by the manufacturer to the owner or operator of the machine. The liquidated damages regulation LD may be defined as a function of an actually reached success value and the guaranteed success probability value p_{g}. For instance, a partial liquidated damages regulation LD may be defined for each percent of which the actually reached success value differs from the guaranteed success probability value p_{g}.

For calculating the penalty, the manufacturer has to pay, one needs hence to calculate the difference between an actually reached success value and the guaranteed success probability value p_{g}. As the manufacturer has to spare a certain amount of money, which has to be paid in case the guaranteed success probability value p_{g} of the machine is not met, the manufacturer has to calculate a risk reserve value. The risk reserve value can be a monetary risk reserve value such as the amount of money which the manufacturer has to put aside for being able to pay the eventually arising penalties. For estimating the amount of money to be paid, which is to calculate the monetary risk reserve value, the manufacturer has to estimate success probability values. A possible success probability value pₐᵢ can be defined as the number of successful start attempts being divided by the number of start attempts. If, for instance, twenty attempts to start the machine are performed, twenty-one different outcomes for the observed starting, reliability are possible. In case all of the twenty attempts to start the machine are successful, a possible success probability value pₐᵢ of 100% is calculated.

In case only fifteen of the twenty start attempts are successful, an possible success probability value pₐᵢ of 75% is calculated. Hence, for each of the number of possible outcomes one possible success probability value pₐᵢ is calculated.

Further, an estimation of a probability occurrence of any value of the possible success probability values pₐᵢ is accomplished. This may be performed as a function of a binomial distribution. In this step it is hence calculated how likely an occurrence of a specific possible success probability value pₐᵢ is. The binomial distribution is calculated as a function of the input parameters number of successful start attempts, number of overall start attempts and the success probability pₛ of the machine. The success probability pₛ may be estimated or determined empirically.

The person skilled in the art may appreciate further methods for estimating the probability of the occurrence of any value of the success probability value pₐᵢ.

In a further step for any value of the possible success probability values pₐᵢ, lower than p_{g}, the difference between the guaranteed success probability p_{g} and pₐᵢ is calculated and multiplied with the probability of occurrence of pₐᵢ and the provided liquidated damages regulation LD. Hence, a partial risk reserve value is calculated. Accordingly, for each difference between the possible success probability values pₐᵢ and the guaranteed success probability value p_{g} one partial risk reserve value is calculated as a function of the provided liquidated damage regulation LD.

In a final step each of the multiplication results, which are the partial risk reserve values, are summed up for calculating an overall risk reserve value.

In an embodiment of the method the probability of occurrence of any value of the possible success probability values pₐᵢ is estimated as a function of the binomial distribution. This provides the advantage that the probability of occurrence is calculated by a well-known statistical distribution which is already implemented in many data processing machines.

In an embodiment of the method summing up each of the multiplication results comprises calculation of a cumulative binomial distribution of successful start attempts j of the machine and the multiplication results to be summed up are selected as a function of comparison of the calculated cumulative binomial function and a provided risk level value. This provides the advantage that a risk level value is provided which allows the manufacturer to limit the risk reserve value. Hence, risks being calculated as a function of a predefined threshold, namely the risk level value, are considered.

In an embodiment of the method, the cumulative binomial distribution is specified as follows:

$${\sum }_{k = 0}^{j - 1} ( \begin{matrix}n \\ k\end{matrix} ) * {p}_{s}^{k} * {( 1 - {p}_{s} )}^{n - k}$$

with provided number j of successful start attempts, the number n of attempts to start the machine and a success probability pₛ. Usage of the cumulative binomial distribution is of advantage. It considers the combination of the number of successful attempts and the number of overall start attempts.

The invention furthermore provides a method for calculating an overall risk reserve value for a machine. The method comprises the following steps:

In a first step a number n of start attempts to start said machine, each start attempt being successful according to a provided success probability value pₛ is performed. The start attempts may for instance be distributed in a specified period of time. For instance, the manufacturer may evaluate how often the machine has to be started within one month. In case the machine has to be started twenty times in the specified period of time, namely one month, then the provided number n equals twenty. It may also be the case that the number n of start attempts is provided as a function of the specified period of time. Hence, the risk reserve value is adapted to the number n of the start attempts within said period of time.

Furthermore, a guaranteed success probability value p_{g} is provided indicating a minimum number of successful starts in case of a shortfall of the number of successful starts a penalty is to be paid as a function of a liquidated damages regulation LD. The liquidated damages regulation LD specifies the penalty value for a difference between the provided guaranteed success probability value p_{g} and the actually reached success value. The guaranteed success probability value p_{g} may for instance be defined in percent. Accordingly, the liquidated damages regulation LD may be defined for each percent that is not reached as regards the guaranteed success probability value p_{g}.

In a next step performing for each number j of possible successful start attempts, wherein the number j of successful start attempts ranges from zero to the number n of starts attempts, the following sub-steps are performed: In a first step a theoretically reached success probability value is calculated by dividing the number j of possible successful start attempts by the number n of start attempts. The theoretically reached success probability value may also be referred to as possible success probability value pₐᵢ.

Furthermore, a cumulative probability cp(j) is performed for the occurrence of at least number j of possible successful start attempts. This may for instance be calculated by the following formula:

cp(j):=1−cumBinomDistribution(j−1) for j>0;

cp(j):=1 for j=0;

with

$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k} .$$

The cumulative-binomial distribution is calculated as a function of the number j of possible successful start attempts, the provided success probability value pₛ and the number of start attempts n.

Furthermore, calculating a binomial distribution of a probability for an occurrence of j successful start attempts, according to the following formula:

$$\begin{matrix}binomDistribution ( j ) := ( \begin{matrix}n \\ j\end{matrix} ) * {p}_{s}^{j} * {( 1 - {p}_{s} )}^{n - j} \\ = probability of occurence of the \\ possible success probability value {p}_{ai}\end{matrix}$$

is performed.

In a subsequent sub-step calculating a partial risk reserve value is performed by weighting the liquidated damages regulation LD with the calculated value binomDistribution(j) wherein the calculated possible success probability value pₐᵢ is lower than the provided guaranteed success probability value p_{g}. This step hence requires a comparison of the calculated possible success probability value pₐᵢ and the provided guaranteed success probability value p_{g}. Hence, only cases where the provided guaranteed success probability value p_{g} is not met are considered for the calculation of the partial risk reserve values.

Furthermore, each partial risk reserve value is summed up to obtain the overall risk reserve value. Summing-up partial risk reserve values may also comprise further sub-steps, such as selecting partial risk reserve values which are to be summed up.

In an embodiment of the method, the guaranteed success probability value p_{g} is defined in percent. This provides the advantage that the guaranteed success probability value p_{g} can be defined as a function of empirical evaluations.

Furthermore, defining the guaranteed success probability value p_{g} as a percentage allows for a fine grained measurement of the achievement of the guaranteed success probability value p_{g}.

In an embodiment of the method according to the present invention, the liquidated damages regulation LD is defined as a monetary value for each percent point of a difference between the guaranteed success probability value p_{g} and the actually reached success value. This provides the advantage that the liquidated damages regulation LD may be defined for each of the percent points individually. Hence, a graded liquidated damages regulation LD can be established.

In an embodiment of the method according to the present invention, the calculation of the partial risk reserve value comprises weighting the liquidated damages regulation LD by the percentage points of the differences between the guaranteed success probability value p_{g} and the possible success probability values p_{gi}. This provides the advantage that the partial risk reserve value can be determined as a function of the liquidated damages regulation LD and the statistically estimated success probability value p_{g}.

In an embodiment of the method, the machine comprises at least one of a group of machines, the machine comprising: a power generator, a power plant, a motor and a computer. This listing is not exhaustive, as the person skilled in the art appreciates other machines or technical devices being comprised in the machine. For instance, a power plant comprises several other technical parts which influence the start probability of the power plant.

The present invention furthermore provides an apparatus for performing the aforementioned methods for calculation of a risk reserve value for a machine. The apparatus comprises a first calculation means for calculating the differences between possible success probability values pₐᵢ, each being lower than a guaranteed success probability value p_{g}, and the guaranteed success probability value p_{g} of said machine. The apparatus furthermore comprises a second calculation means for estimating a probability of occurrence of any value of the possible success probability values pₐᵢ. Furthermore, a third calculation means is comprised in the apparatus for multiplying the calculated differences with the estimated probability of occurrence of any value of the possible success probability values pₐᵢ and a provided liquidated damages regulation LD. Also, a fourth calculation means is comprised in said apparatus for summing up each of the multiplication results for obtaining the risk reserve value.

The present invention further provides an apparatus for calculation of an overall risk reserve value for a machine. Said apparatus comprises a first calculation unit for provision of any number of n of start attempts to start said machine, each start attempt being successful according to a provided success probability value pₛ. The apparatus further comprises a second calculation unit for provision of a guaranteed success probability value p_{g} indicating a minimum number of successful starts. In case of a shortfall of the number of successful starts, a penalty is to be paid as a function of a liquidated damages regulation LD. The liquidated damages regulation LD specifies a penalty value for a difference between the provided guaranteed success probability value p_{g} and the actually reached success value. The apparatus further comprises a third calculation unit for performing for each number j of possible successful start attempts, wherein the number j of possible successful start attempts ranges from zero to the number n of start attempts, the following sub-steps:

First, a theoretically possible success probability value is calculated by dividing number j of possible successful start attempts by the number n of start attempts. In a subsequent step, a cumulative probability cp(j) of the occurrence of at least the number j of possible successful start attempts is calculated according to the following formula:

cp(j):=1−cumBinomDistribution(j−1) for j>0;

cp(j):=1 for j=0;
with

$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k} .$$

Furthermore, a binomial distribution of a probability for an occurrence of j successful start attempts is calculated according to the following formula:

$$binomDistribution ( j ) := ( \begin{matrix}n \\ j\end{matrix} ) * {p}_{s}^{j} * {( 1 - {p}_{s} )}^{n - j} .$$

In a final sub-step a partial risk reserve value is calculated by weighting the liquidated damages regulation LD with the calculated value binomDistribution(j), wherein the calculated possible success probability values pₐᵢ are lower than the provided guaranteed success probability value p_{g}.

The apparatus for calculation of overall risk reserve value for a machine furthermore comprises a fourth calculation unit for summing up each partial risk reserve value to obtain the overall risk reserve value.

The aforementioned calculation means as well as the aforementioned calculation units can be implemented as a processor, a microprocessor, a computer, a computer system, a central processing unit, an arithmetical operating unit and/or a circuit.

The invention furthermore provides a computer program being adapted to perform the aforementioned method on a computer. The computer program can be stored on a data carrier.

### BRIEF DESCRIPTION OF THE FIGURES

FIG. 1 shows a diagram illustrating an application scenario of an aspect of the method for calculating a monetary risk reserve value;

FIG. 2 shows a diagram of a cumulative binomial distribution of a start reliability as used by the method for calculating a monetary risk reserve value;

FIG. 3 shows a flow diagram of a possible embodiment of a method for calculating a monetary risk reserve value;

FIG. 4 shows a detailed flow diagram of a method of a possible embodiment for calculating an overall risk reserve value;

FIG. 5 shows a block diagram of a possible embodiment of an apparatus for calculation of a monetary risk reserve value;

FIG. 6 shows a detailed block diagram of a possible embodiment of the apparatus for calculation of a monetary risk reserve value;

FIG. 7 shows a block diagram of a possible embodiment of the apparatus for calculation of an overall monetary risk reserve value; and

FIG. 8 shows a table demonstrating a calculation of an overall risk reserve value according to a possible embodiment of the method for calculating an overall risk reserve value.

### DETAILED DESCRIPTION OF EMBODIMENTS

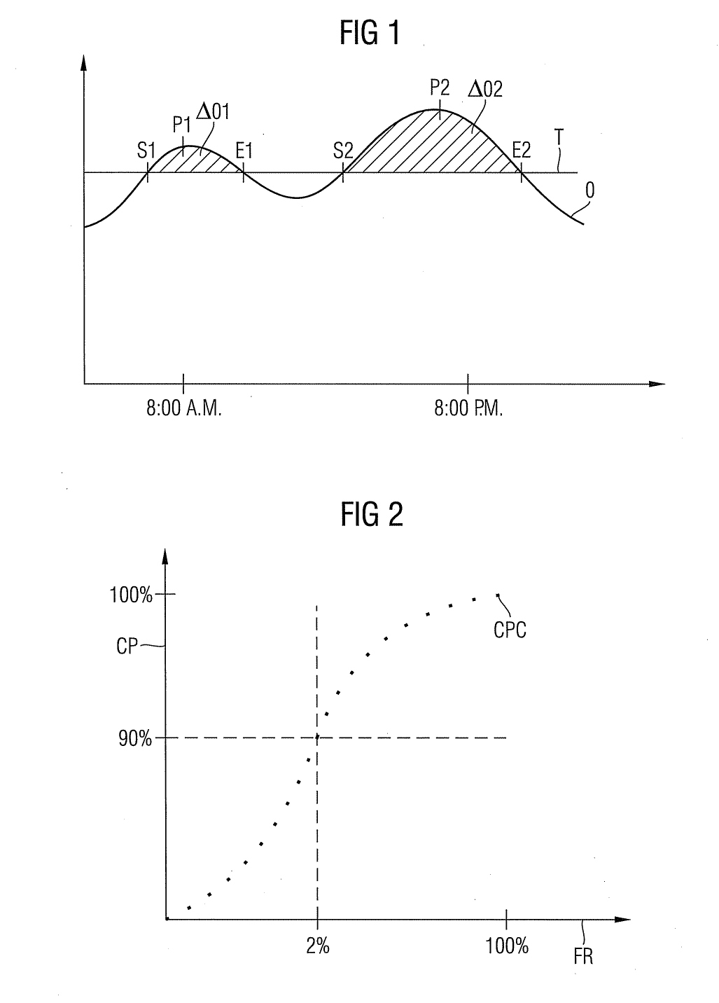

FIG. 1 shows an illustration of an application scenario requiring a method for calculating a risk reserve value for a machine. The present diagram of FIG. 1 shows the consumption of an output of a machine. In the present application scenario of the method for calculating a risk reserve value the machine is a power plant which has to provide electricity for customers.

In the present application scenario as depicted in FIG. 1 a set of power plants delivers electricity up to a predefined threshold T. It may occur during the rush hours from 7:00 am to 9:00 A.M. and an according time in the evening, that peaks P1 and P2 occur regarding the consumption of electricity. In case of a peak P1, P2 of consumption of electricity that an additional power plant is required to provide a certain electricity value ΔO1, ΔO2 for the customers. Hence, the additional power plant has to be switched on during a start time of S1 and S2 and has to be switched off at the end times E1, E2 of the respective rush hours. During a period of time between E1 and S2 the additional power plant is switched off. Hence it may occur, that the additional power plant has to be switched on and off several times a day.

As power plants are complex machines comprising several parts and devices it is possible that a specific power plant does not start exactly at the required point of time S1, S2. The owner/operator of the power plant requires a specification of the start reliability of the power plant. Furthermore, it may be the case that the owner/operator of the power plant demands a penalty for a number of unsuccessful starts of the power plant.

An unsuccessful start of the power plant is for instance if the power plant fails to provide the demanded amount of electricity ΔO1, ΔO2. A successful start delivers the required output ΔO1, ΔO2 exactly at a specified point of time S1, S2 or delivers the required output ΔO1, ΔO2 within a specified period of time.

In case the power plant does not start properly the power plant is not able to provide the customer with the required output ΔO of electricity. For this case the owner/operator may demand a penalty from the manufacturer of the power plant according to a predefined contract. The penalty can be a payment or another kind of penalty, e.g. supply of additional energy from another power plant. This contract may for example define that for each failed start or restart of the power plant a certain amount of money has to be paid. The contract may also specify that for a certain percentage of failure, which means unsuccessful starts of the power plant, a specified penalty has to be observed by the manufactures. The manufacturer of the power plant has to save money for serving the operator's penalty demands. In another embodiment the manufactures provides the capacity to perform a penalty in the form of an energy supply from another source, or power plant with an additional penalty quantity of energy or power. For example the manufacturer might have a contract with another operator to supply the penalty quantity of energy or power. This penalty sum or energy has to be put aside in advance regarding the operation of the power plant. Therefore it is necessary to estimate the potential penalty payments or supply in advance. Hence, the manufacturer has to calculate in a possible embodiment a monetary risk reserve value, also referred to as penalty payment. The calculation of the monetary risk reserve value also affects design decisions regarding the construction of the power plant, as the manufacturer accomplishes improvements in the construction of the power plant amongst others considering the calculated monetary risk reserve value.

FIG. 2 shows a diagram of a binomial distribution of a start reliability of a machine. The binomial distribution is calculated according to an aspect of an embodiment of the present invention. The diagram shows the failure rate FR of the machine on the x-axis. The y-axis shows a cumulative probability of the occurance of specific start unreliabilties.

In an embodiment the method for calculating a risk reserve value for a machine, the manufacturer of the machine guarantees the operator of the machine, also called the owner of the machine, a success probability of 98%. The manufacturer may for instance estimate that the guaranteed 98% can be reached in about 90% of the overall start attempts. The manufacturer of the machine may furthermore estimate that it is feasible to reach a success probability of 97% in about 95% of all attempted starts. The occurance of the 98% and 97% of successful starts are hence indicated along the x-axis. The occurance of said 98% and 97%, namely the 90% and 95% are indicated along the y-axis.

For calculation of a risk reserve value the manufacturer of the machine calculates the cumulative probability curve CPC for estimating the overall risk reserve value. As depicted in FIG. 2 a reliability of at least 98%, which means a failure rate of at most 2%, appears with a probability of 90%. Hence the manufacturer has to pay a penalty for unsuccessful starts with a probability of 10%.

It may also occur that the machine fails to start in a 100%, which means at a failure rate of 100%. Hence the cumulative probability is also 100%, as a reliability of 0% is covered at a probability of 100%. As at a failure rate of 100% the machine is always out of order, the manufacturer estimates that this can be guaranteed in any case. Accordingly, a failure rate of 0% occurs in typically less than a 100% of start attempts.

The y-axis further indicates the risk the manufacturer is subject to. To guarantee a low failure rate, for instance between 0 and 2% than this is of high risk. Guaranteing a failure rate of a 100% is of no risk for the manufacturer and can be guaranteed in a 100% of cases.

While the cumulative probability curve CPC reflects only technical issues of the starting behaviour of the machine, the indicated failure rate of 2% is defined/guaranteed in a contract. The guaranteed failure rate is negotiated between the manufacturer and the owner of the machine and serves as an “assurance” for the owner/operator of the machine.

The diagram depicted in FIG. 2 is of importance for the manufacturer of the machine for estimating penalty payments as regards the guaranteed success probability of the machine.

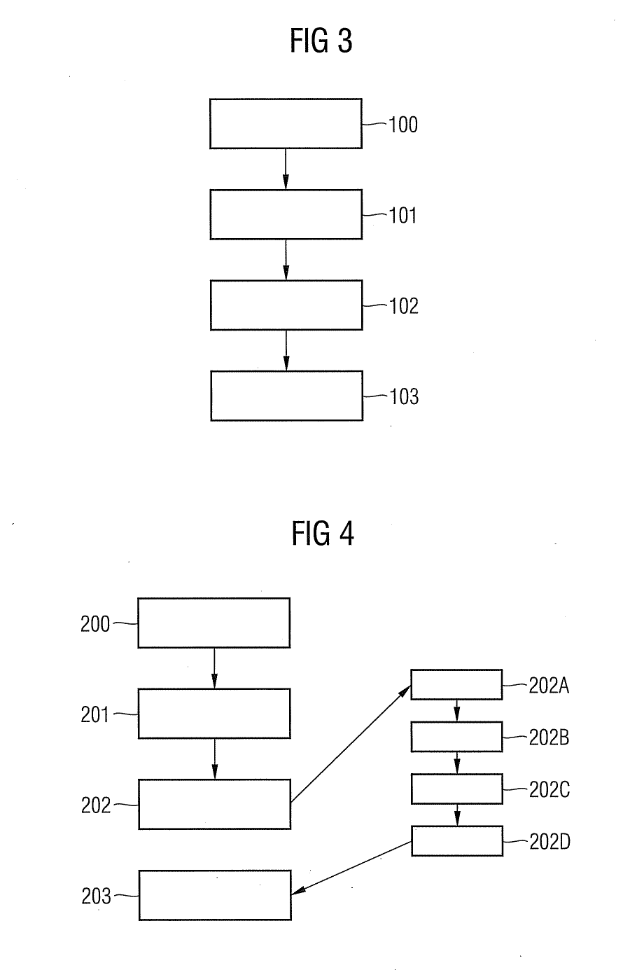

FIG. 3 shows a flow diagram of a possible embodiment of a method for calculating a monetary risk reserve value for a machine. The method comprises the following steps:

In a first step (100) differences between possible success probability values pₐᵢ, each being lower than a guaranteed success probability value p_{g}, and the guaranteed success probability value p_{g} of said machine are calculated. The possible success probability values pₐᵢ may for instance be estimated on the basis of 20 start attempts and each number of successful starts. Hence 21 possible success probability values pₐᵢ are estimated for performing the step 100 of calculating the differences between the possible success probability values pₐᵢ and the guaranteed success probability value p_{g}. The guaranteed success probability value p_{g} may for instance be defined in a contract between the manufacturer of the machine and the owner/operator. At twenty start attempts the machine may for instance perform successful starts at an estimated success probability pₐᵢ of 85%. Hence the machine started seventeen times successfully out of twenty start attempts.

As no penalty payment has to be made by the manufacturer in case the success probability value is above the guaranteed success probability value p_{g}, those possible success probability values pₐᵢ being above the guaranteed success probability value p_{g} may not be considered in calculating the monetary risk reserve value.

In a further step (101) a probability of occurance of any value of the possible success probability values pₐᵢ is estimated. The step 101 may be performed as a function of a binomial distribution. Said binomial distribution is manifested in detail in FIG. 2. The estimation of the probability of occurance of any value of the possible success probability values pₐᵢ may for instance be performed as a function of a binomial distribution. The person skilled in the art appreciates that further statistical approaches are applicable for estimating the probability of occurance of any value of the possible success probability values Pal.

Further the calculated differences, which are calculated in step 100 are multiplied in step 102, with the estimated probability of occurance of any value of the possible success probability values pₐᵢ, as estimated in step 101, and a provided liquidated damages regulation LD. The provided liquidated damages regulation LD specifies penalty values, which have to be paid in case the guaranteed success probability value p_{g} is not reached. The provided liquidated damages LD may for instance be a amount of money for each percent of the actually reached success value being lower than the guaranteed success probability value p_{g}.

In a final step (103) each of the multiplication results as obtained in step 102 are summed up. The summing up of the multiplication results in step 103 may also comprise further sub-steps, such as the selection of specific multiplication results.

The possible success probability values pₐᵢ, the guaranteed success probability value p_{g} and the liquidated damages regulation LD may be empirically estimated, calculated or provided by a data carrier.

The aforementioned steps may be performed iteratively and/or in a different order.

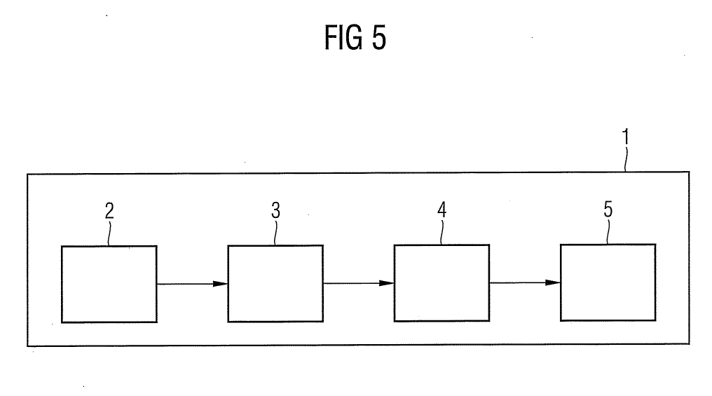

FIG. 4 shows a detailed flow diagram of a possible embodiment of a method for calculating an overall risk reserve value for a machine. The method comprises the following steps:

In a first step (200) providing a number n of start attempts to start said machine, each start attempt being successful according to a provided success probability value pₛ is accomplished. The provided number n of start attempts as well as the provided success probability value pₛ may serve as input parameters for calculation of a binomial distribution and a cumulative binomial distribution as performed in steps 202B and 202C.

Furthermore providing in step 201a guaranteed success probability value p_{g}. The provided guaranteed success probability value p_{g} indicates a minimum number of successful starts. In case of a shortfall of the number of successful starts, which means if the provided success probability value p_{g} is not met, a penalty is to be paid as a function of a liquidated damages regulation LD. The liquidated damages regulation LD specifies a penalty value for a difference between the provided guaranteed success probability value p_{g} and the actually reached success value.

It may be the case that the liquidated damages regulation LD is defined for percent points or for ranges of percent points. The liquidated damages regulation LD may for instance be a penalty value of 10000 $ for each percent point the actual reached success value falls below the guaranteed success probability value p_{g}.

In a further step 202 a number of sub-steps is performed. For each number j of possible successful start attempts, wherein the number j of possible successful start attempts ranges from zero to the number n of start attempts said sub-steps are performed as follows:

First a theoretically possible success probability value pₐᵢ is calculated in sub-step 202A by dividing the number j of possible successful start attempts by the number n of start attempts. In a further sub-step 202B calculating a cumulative probability cp(j) is performed. The cumulative probability cp(j) is performed for the occurrence of at least the number j of possible successful start attempts, according to the following formula:

cp(j):=1−cumBinomDistribution(j−1) for j>0;

cp(j):=1 for j=0;
with

$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k}$$

In a subsequence sub-step 202C a binomial distribution of a probability for an occurrence of j successful start attempts is calculated. This is accomplished according to the following formula

$$binomDistribution ( j ) := ( \begin{matrix}n \\ j\end{matrix} ) * {p}_{s}^{j} * {( 1 - {p}_{s} )}^{n - j}$$

In a final sub-step 202D a partial risk reserve value is calculated. This is accomplished by weighting the liquidated damages regulation LD with the calculated value binomDistribution(j), wherein the possible success probability values pₐᵢ are lower than the provided guaranteed success probability value p_{g}.

In the sub-step 202D partial risk reserve values are calculated for each difference of the possible success probability values pₐᵢ and the guaranteed success probability value p_{g}.

Hence the calculated partial risk reserve values, as calculated in sub-step 202D, are summed up for obtaining the overall risk reserve value. Summing each partial risk reserve value is accomplished in a final step 203.

FIG. 5 shows a block diagram of a possible embodiment of the apparatus 1 for calculation of a risk reserve value for a machine. The apparatus 1 comprises:

A first calculation means 2 for calculating the differences between possible success probability values pₐᵢ, each being lower than a guaranteed success probability value p_{g}, and the guaranteed success probability value p_{g} of said machine. The apparatus 1 furthermore comprises a second calculation means 3 for estimating a probability of occurrence of any value of the possible success probability values pₐᵢ. The apparatus 1 also comprises a third calculation means 4 for multiplying the calculated differences with the estimated probability of occurrence of any value of the possible success probability values pₐᵢ and a provided liquidated damages regulation LD. The apparatus 1 for calculation of a risk reserve value also comprises a fourth calculation means 5 for summing up each of the multiplication results for obtaining the risk reserve value.

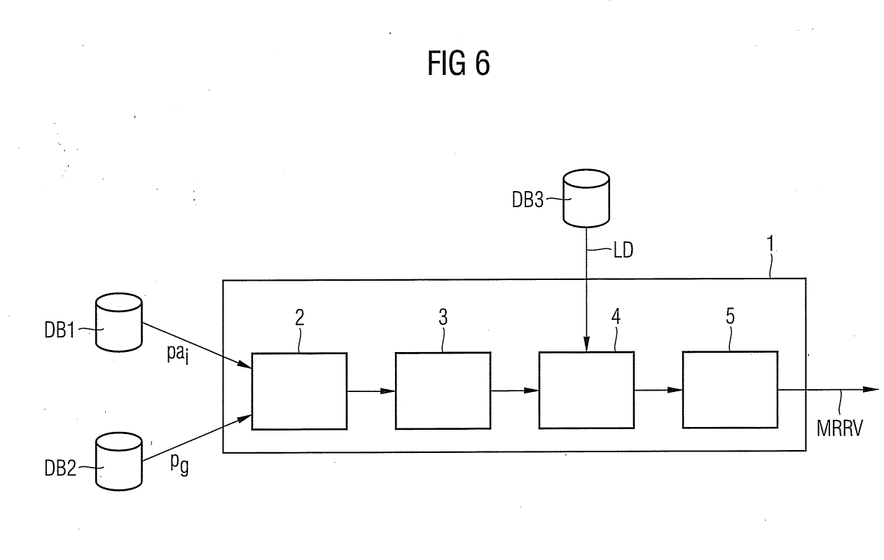

FIG. 6 describes the apparatus for calculation of a risk reserve value for a machine and differs from the apparatus 1, as described in FIG. 5 as follows:

In the present embodiment of the apparatus 1 the first calculation means 2 accesses a data base DB1 for looking up the possible success probability values pₐᵢ. Furthermore the first calculation means 2 accesses a further data base DB2 for looking up the guaranteed success probability value p_{g}. The data bases DB1 and DB2, which provide the possible success probability values pₐᵢ as well as the guaranteed success probability value p_{g} respectively, may be comprised in one single data base or may be separate data bases.

In the present embodiment of the apparatus 1 a further apparatus has stored the possible success probability values Pal as well as the guaranteed success probability value p_{g} in said data basis DB1 and DB2.

The third calculation means 4 accesses a data base DB3 for reading out the liquidated damages regulation LD. The liquidated damages regulation LD may for instance be comprised in a contract, which is stored in the data base DB3. The contract may be specified in an xml-document which is parsed for extracting the liquidated damages regulation LD.

The data bases DB1, DB2 and DB3 may for instance be a storage means, for instance a hard drive, a flash disk, a USB storage device, a floppy disk, a disk, a CD, a DVD, a blu ray disk, a removable storage or may be a virtual, data base being stored on a storage device. The data bases DB1, DB2 and DB3 are accessed over a network, the network comprising further network components. The calculation means, especially the calculation means 2, 3, 4 and 5 may be formed as any kind of processor, micro processor, computer, computer system, central processing unit, arithmetical calculation device and/or as a circuit. The monetary risk reserve value may be output by any kind of interfaces, such as a further storage device or a graphical user interface.

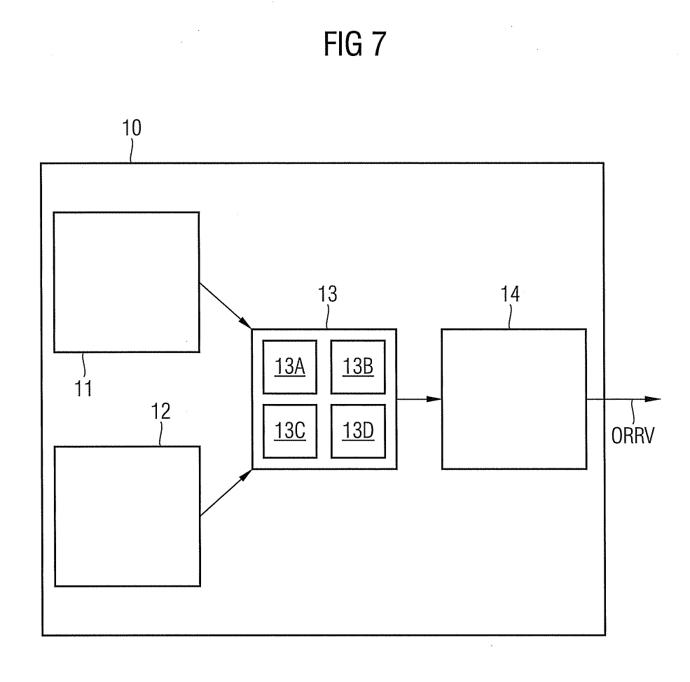

FIG. 7 shows a block diagram of an apparatus 10 for calculation of an overall risk reserve value ORRV for a machine. The apparatus 10 comprises a first calculation unit 11 for provision of a number n of start attempts to start said machine, each start attempt being successful according to a provided success probability value pₛ. The apparatus 10 further comprises a second calculation unit 12 for provision of a guaranteed success probability value p_{g}. The guaranteed success probability value p_{g} indicates a minimum number of successful starts, in case of a shortfall of the number of successful starts a penalty is to be paid as a function of a liquidated damages regulation LD. The liquidated damages regulation LD specifies a penalty value for a difference between the provided guaranteed success probability value p_{g} and the actually reached success value. The apparatus 10 also comprises a third calculation unit 13 for performing for each number j of possible successful start attempts, wherein the number j of possible successful start attempts ranges from zero to the number n of start attempts the following sub-steps:

A first sub-step is to calculate a theoretically possible success probability value pₐᵢ by dividing the number j of possible successful start attempts by the number n of start attempts. Furthermore calculating a cumulative probability cp(j) of the occurrence of at least the number j of possible successful start attempts, is performed according to the following formula

cp(j):=1−cumBinomDistribution(j−1) for j>0;

cp(j):=1 for j=0;
with

$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k}$$

In a subsequent sub-step calculating a binomial distribution of a probability for an occurrence of j successful start attempts, is performed according to the following formula

$$binomDistribution ( j ) := ( \begin{matrix}n \\ j\end{matrix} ) * {p}_{s}^{j} * {( 1 - {p}_{s} )}^{n - j}$$

In a further sub-step performed by the third calculation unit 13 calculating a partial risk reserve value by weighting the liquidated damages regulation LD with the calculated value binomDistribution(j), wherein the possible success probability value pₐᵢ is lower than the provided guaranteed success probability value p_{g} is performed.

A fourth calculation unit 14 is provided with the calculated partial risk reserve values. In the fourth calculation unit 14 sums each partial risk reserve value to obtain the overall risk reserve value.

In the present embodiment of the apparatus 10 for calculation of an overall risk reserve value ORRV the sub-steps may either be calculated directly by the third calculation unit 13, or may be calculated by the calculation means 13A, 13B, 13C and 13D, each performing at least one sub-step.

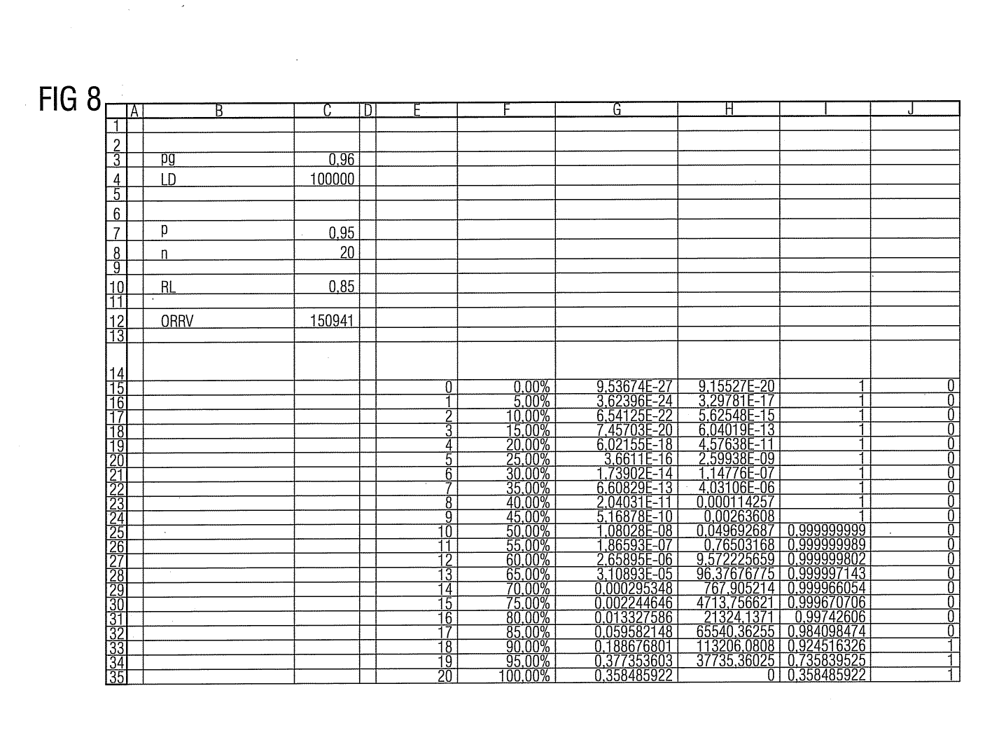

FIG. 8 describes an exemplary calculation of an overall risk reserve value according to a possible embodiment of the method for calculating an overall risk reserve value for a machine.

In the present table being depicted in FIG. 8 values are referenced by cell identifiers. A cell identifier is compound of a column identifier A to J as well as a row identifier 1 to 35. For instance cell C3 refers to the value of column C and row 3.

In cell C3 a guaranteed success probability value p_{g}=0,96 is present. Cell C4 shows a liquidated damages regulation of 100000 $ for each percent of a difference between the guaranteed success probability value p_{g} and an actually reached success value. Cell C7 shows the expected mean success probability value pₛ, that said machine starts properly. This is a technical parameter which is based on the technical conception of the machine. In cell C8 the number of start attempts n is defined as 20. Hence a maximum of 20 successful starts is possible for the machine, as also indicated in cell E35. Furthermore, a risk level value RL is specified in cell C10. The risk level value RL is specified as 0,85. In C12 the result of the calculation of the overall risk reserve value is presented, which is calculated as a function of the calculation results demonstrated in columns E to J.

The column E describes the number of possible successful start attempts j. Said number of possible successful starts ranges from 0 to 20, as the number n of start attempts is defined as 20.

In column F the possible start reliabilities are determined. For instance, if the machine starts 11 times successfully out of 20 start attempts the success probability of the machine is defined as 55% as indicated in cell F26.

In column G the probability for exactly j successful start attempts is calculated. In the present embodiment of the method for calculating an overall risk reserve value the calculation of the probability of exactly j successful start attempts is accomplished as a function of binomial distribution. Input parameters for the binomial distribution are the respective value j of successful start attempts as defined in column E, the number of overall start attempts, as defined in cell C8 as well as the success probability, as defined in cell C7. The probability for exactly j successful start attempts is calculated for each row with the input parameter j being defined in the same row of column E.

In column H the risk of the manufacturer of the machine is defined. The values defined in column H may also be referred to as partial risk reserve values. They represent partial risk reserve values which are in at least one further step summed up towards the overall risk reserve value as defined in cell C12. The values of column H are defined as the weighted difference of the possible success probability values pₐᵢ as defined in column F and the guaranteed success probability value p_{g} as defined in cell C3.

The weighting of the difference of each value of column H is performed by multiplying the difference with the liquidated damages regulation LD being defined in cell C4 and the probability for the occurrence of exactly j successful start attempts as being defined in column G. Only in case the possible success probability value pₐᵢ is below the guaranteed success probability value p_{g} a penalty has to be paid. Hence cell H35 equals zero, as the possible success probability value pₐᵢ of 100% is above the guaranteed success probability value p_{g}.

Column I describes the cumulative binomial distribution of at least j successful start attempts. The values of column H are calculated by the following equation

1−Binomvert(j,n,p)

with Binomvert( ) calculating the cumulative binomial distribution of the values being represented in column E respectively, cell C8 and C7.

Column J describes a boolean value for the presence of a potential partial risk reserve value. The values of column J are calculated for each row by the following if, then, else function: For instance cell J28 is defined as “if 128 is greater or equals cell C10 and cell 129 is greater or equals cell C10, then the value 0 is input”. If said condition is not true, the value 1 is inserted.

In a final step a cell C12 is calculated, indicating the overall risk reserve value ORRV. In the cell C12 the partial risk reserve values of column H are selected and summed up.

In the present embodiment only the partial risk reserve values of column H are selected, which have the value 1 in the respectively same row of column J. Hence only cells H33, H34 and H35 selected for being summed up. Hence the overall risk reserve value of 150941 $ is calculated.

Hence the manufacturer of the machine knows that with the parameters defined in cell C3 to C10 a monetary risk reserve value of 150941 $ has to be spared for potential penalty payments to the operator of the machine.

The method and apparatus of the present invention are not restricted to the embodiments described above but further embodiments and variants are possible. For example the risk reserve value is not restricted to a monetary value but can also be value for a physical entity such as energy or power to be supplied as a penalty by the manufactures.

1.-13. (canceled)

14. A method for calculating a risk reserve value for a machine, comprising:
calculating a plurality of differences between a plurality of possible success probability values and a guaranteed success probability value of the machine;
estimating a probability of occurrence of any value of the plurality of possible success probability values;
multiplying the plurality of calculated differences and a provided liquidated damages regulation; and
summing up each of the multiplication results to obtain the risk reserve value,
wherein each possible success probability value is lower than the guaranteed success probability value.

15. The method as claimed in claim 14, wherein the probability of occurrence of any value of the plurality of possible success probability values is estimated as a function of a binomial distribution.

16. The method as claimed in claim 14,
wherein the summing up comprises calculating a cumulative binomial distribution of a plurality of successful start attempts of the machine, and
wherein the multiplication results are selected as a function of a comparison of the calculated cumulative binomial function and a provided risk level value.

17. The method as claimed in claim 16, wherein the calculated cumulative binomial distribution is specified as follows:
$$cumBinomDistribution ( j ) := {\sum }_{k = 0}^{j - 1} ( \begin{matrix}n \\ k\end{matrix} ) * {p}_{s}^{k} * {( 1 - {p}_{s} )}^{n - k}$$
with a number j of successful start attempts, the number n of start attempts and a success probability pₛ.

18. A method for calculating an overall risk reserve value for a machine, comprising:
providing a number of start attempts, the number of start attempts defined as the number of times an attempt to start the machine is made, each start attempt is successful according to a provided success probability value;
providing a guaranteed success probability value indicating a minimum number of successful starts;
performing a plurality of calculations for each value of possible successful start attempts, the number of possible successful start attempts ranges from zero to the number of start attempts, the performing comprises:
calculating a theoretically possible success probability value by dividing the number of possible successful start attempts by the number of start attempts,
calculating a cumulative probability of the occurrence for at least the number of possible successful start attempts, according to the following formula:
cp(j):=1−cumBinomDistribution(j−1) for j>0;
cp(j):=1 for j=0;
with
$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k} ,$$
calculating a binomial distribution of a probability for an occurrence of the number of successful start attempts, according to the following formula:
$$binomDistribution ( j ) := ( \begin{matrix}n \\ j\end{matrix} ) * {p}_{s}^{j} * {( 1 - {p}_{s} )}^{n - j} ,$$
calculating a partial risk reserve value by weighting a liquidated damages regulation with the calculated value binomDistribution(j), wherein the possible success probability value is lower than the provided guaranteed success probability value;
summing each partial risk reserve value to obtain the overall risk reserve value,
wherein when a number of successful starts is below the minimum number of successful starts a penalty is determined as a function of a liquidated damages regulation, the liquidated damages regulation specifies a penalty value for a difference between the provided guaranteed success probability value and an actually reached success value.

19. The method as claimed in claim 18, wherein the guaranteed success probability value is defined as a percentage.

20. The method as claimed in claim 19, wherein the liquidated damages regulation is defined as a monetary value for each percentage point of a difference between the guaranteed success probability value and the actually reached success value.

21. The method according to claim 20, wherein the calculation of the partial risk reserve value comprises weighting the liquidated damages regulation by a plurality of percentage points of the plurality of differences between the guaranteed success probability value and the plurality of possible success probability values.

22. The method as claimed in claim 18, wherein the machine is selected from the group consisting of a power generator, a power plant, a motor and a computer and combinations thereof.

23. An apparatus for performing a method for calculating of an overall risk reserve value for a machine, comprising:
a first calculation unit for provision of a number of start attempts, the number of start attempts defined as the number of times an attempt to start the machine is made, each start attempt is successful according to a provided success probability value;
a second calculation unit for provision of a guaranteed success probability value indicating a minimum number of successful starts;
a third calculation unit for performing a plurality of calculations for each value of possible successful start attempts, the number of possible successful start attempts ranges from zero to the number of start attempts, the performing comprises:
calculating a theoretically possible success probability value by dividing the number of possible successful start attempts by the number of start attempts,
calculating a cumulative probability of the occurrence for at least the number of possible successful start attempts, according to the following formula:
cp(j):=1−cumBinomDistribution(j−1) for j>0;
cp(j):=1 for j=0;
with
$$cumBinomDistribution ( j - 1 ) := {\sum }_{k = 0}^{j - 1} ( \begin{matrix}n \\ k\end{matrix} ) * {p}_{s}^{k} * {( 1 - {p}_{s} )}^{n - k}$$
calculating a binomial distribution of a probability for an occurrence of the number of successful start attempts, according to the following formula
$$binomDistribution ( j ) := ( \begin{matrix}n \\ j\end{matrix} ) * {p}_{s}^{j} * {( 1 - {p}_{s} )}^{n - j}$$
calculating a partial risk reserve value by weighting a liquidated damages regulation with the calculated value binomDistribution(j), wherein the possible success probability value is lower than the provided guaranteed success probability value;
a fourth calculation unit for summing up each partial risk reserve value to obtain the overall risk reserve value;
wherein when a number of successful starts is below the minimum number of successful starts a penalty is determined as a function of a liquidated damages regulation, the liquidated damages regulation specifies a penalty value for a difference between the provided guaranteed success probability value and an actually reached success value.
